(19) United States
(12) Patent Application Publication
(10) Pub. No.: US 2005/0125246 A1
(43) Pub. Date: Jun. 9, 2005

(54) Participant tool to support online meetings

(75) Inventors: Michael Muller, Medford, MA (US); Sara Beth Weber, Arlington, MA (US); Anne Rebecca Braunstein, Needham, MA (US); Martin Thomas Moore, San Francisco, CA (US); Cengiz H. Satir, Amesbury, MA (US)

Correspondence Address: RICHARD M. GOLDMAN, 371 ELAN VILLAGE LANE, SUITE 208, CA, 95134, US

(73) Assignee: International Business Machines Corporation

(21) Appl. No.: 10/731,573

(22) Filed: Dec. 9, 2003

(51) Int. Cl. G06F 17/60

(52) U.S. Cl. 705/1; 705/26

(57) ABSTRACT

Method, system and program product for conducting an on-line meeting. An on-line meeting participant application is used to enumerate the participants, including identifying each of the individual participants to individual on-line meeting sites, and publishing an agenda to enumerated participants. Individual participant inputs are collected from the individual participants and published in accordance with participant attributes.

### FIELD OF THE INVENTION

Our invention relates to computer based conferencing and collaboration, including group decision support, education and training, and brainstorming, and more specifically to computer systems and methods for facilitating on-line conferencing and collaborative work among multiple users, where users at multiple locations join in completing a given task as a group. In this way, data from the multiple participants at the multiple sites is distributed to other participants at the other collaborative sites.

### BACKGROUND

One method of on-line collaboration is through on-line meetings. The typical configuration for on-line meetings has been a plurality of users, each of whom operates her or his own computer or workstation (“one-computer/one-user”). More recently, a hybrid form of on-line meeting has emerged, in which some participants gather around a single computer, often with a projection display, in a conference room (“one-computer/many-users”), and other participants at remote locations adopt the “traditional” “one-computer/one-user” mode of access. In more complex cases, there may be more than one conference room, with more than one group of users gathered around a single computer in each conference room. In these configurations, there may then be a plurality of “one-computer/one-user” settings and a plurality of “one-computer/many-users” settings. The methods of providing meaningful access by all users in these hybrid on-line meeting configurations are an area of on-going research and invention.

An open issue with on-line meetings is providing all of the invitees and attendees, or a sub-set of the invitees and attendees, a list of the invitees, the invitees who have accepted and those who have declined, and a real-time listing of the present attendees and their attributes, that is, their access authorizations and their locations, for example, to facilitate “one-computer/many-users” activities. A second open issue, particularly with regard to hybrid on-line meetings, is the problem of passing these and other participant parameters to other conferencing and collaboration tools and other conferencing sites.

### SUMMARY OF THE INVENTION

These and other issues are addressed by the method, system, and program product of our invention. The method, system, and program product described herein make it possible to centralize and effectively manage, and utilize, lists of the invitees, the invitees who have accepted and those who have declined, the present attendees, and participant parameters, and their collaborative conferencing and participation tools.

According to the method, system and program product of our invention, a participant application is provided to facilitate establishing and conducting an on-line meeting. The meeting process is initiated by enumerating the participants, including identifying each of the individual participants to individual on-line meeting sites, and invoking the meeting. The meeting (including meeting tools and applications) may be invoked by, for example, publishing an agenda to enumerated participants, publishing an invitation list, or, even, invoking the meeting ad hoc from an instant messaging or Lotus SameTime instant messaging environment.

In the case of ad hoc invocation, the participant tool can be used to allow participants in a Lotus SameTime instant meeting chat to upgrade the chat environment to an instant meeting environment. An ad hoc meeting would normally be conducted without a formal agenda (that is, an agenda that uses an agenda tool), and without formal invitations, but with access to voting tools, brainstorming tools, group decision support tools, collaboration tools, and the like.

Individual participant inputs are collected from the individual participants and published in accordance with participant attributes.

A further aspect of the invention is a participant voting tool, which is typically adapted to accept participant votes from an on-line meeting site. Normally such tools are a “one-computer/one-user/one-vote” tool, however, in a hybrid on-line meeting, annotation of the participant database with participant location attributes and suitable participant coding allows “one-computer/many-users/many-votes but one-vote-per-user” where the number of participant votes from an individual on-line meeting site is the number of participants identified to the individual on-line meeting site in the participant database.

Another aspect of our invention is the facilitation of on-line brainstorming sessions. Brainstorming tools allow each of a plurality of users to input her or his own text onto a common list or whiteboard. Certain aspects of brainstorming, often called “round-robin brainstorming,” establish a sequence of participants, and each participant is allowed to add a single idea only during her or his established “turn” in the sequence. In the conventional “one-computer/one-user” configuration, this round-robin brainstorming may be conducted by accepting input up to a designated “send” command (typically a “return” character) from each user (each computer) in sequence (i.e., “one-computer/one-user/one-idea”). However, in a hybrid on-line meeting, the method, system, and program product described herein mixes this mode for “one-computer/one-user” situations, with a more complex mode in which, for the “one-computer/many-users” situations, the number of ideas that are received from each conference room is calibrated to the number of participants in that conference room (i.e., “one-computer/many-users/many-ideas but one-idea-per-user”).

A further aspect of the method, system, and program product of our invention is its use in an on-line educational setting, in which each of a plurality of audience members may be granted “equal access” to present questions to the lecturer or speaker. As above, for the conventional “one-computer/one-user” configuration, equal access to present questions may be provided by accepting one question from each computer in an established sequence. However, for the hybrid on-line meeting, there is a need to mix the “one-computer/one-user/one-question” mode with a more complex “one-computer/many-users/many-questions but one-question-per-user” mode.

A further aspect of the method and system of the invention is interactivity, including accepting participant comments from participants, optionally with aggregation of participant comments, and also with publication or broadcast of the comments.

As a collaborative tool, the method and system can open objects and tools identified to the conference. By “objects” we mean files, conference databases, wiki tools and the like. In this context, a file or other object, for example, a file or object identified in the agenda, or in a real time instant messaging environment, or called by a participant, can be opened to identified on-line meeting participants. Participants with entries indicating that they have been granted access, can view and modify the object. This includes accepting and recording participant inputs to the object from other participants, and updating the object, with the updated file being published to on-line meeting participants.

### THE FIGURES

Various aspects of the method and system of our invention are illustrated in the Figures appended hereto.

FIG. 1 is a schematic diagram of a system for carrying out the method of our invention.

FIG. 2 is a simplified flow chart of one embodiment of the invention.

FIG. 3 is an e-mail screen with a meeting invitation, inviting a participant to attend an on-line meeting.

FIG. 4 shows a participant's screen, with an agenda item, the meeting agenda, and an enumeration of proposed agenda items.

FIG. 5 shows a participant's screen with a reminder of unfinished tasks, an instant message, and a segment of the proposed agenda item list.

FIG. 6 illustrates the instant message panel, which can also be used for “brainstorming” sessions and “group decision support” sessions.

FIG. 7 illustrates a screen display of a meeting agenda.

FIG. 8 illustrates a screen display of on-line voting results, which may include “one-computer/many-users/many-votes but one-vote-per-user” aggregated results and tallies.

FIG. 9 illustrates a screen display for a new action item.

FIG. 10 illustrates a screen display notifying a participant of a new action item.

FIG. 11 illustrates a screen display of an on-line meeting agenda, the meeting agenda, and the present on-line participants.

FIG. 12 illustrates another unfinished pre-meeting work item notification.

FIG. 13 is a complete agenda for a future meeting.

### DETAILED DESCRIPTION

The method, system, and program product of our invention enables participants in on-line meetings and collaboration sessions to manage and monitor invitations, acceptances, and rejections before the on-line meeting or collaboration meeting, as well as providing enhanced information about each member of the on-line or collaboration meeting. A still further aspect of the invention is passing of information to parameterize participant attributes including participant participation attributes, as well as other collaboration and on-line meeting tools.

The method and system described herein facilitates conducting an on-line meeting. The method is initiated by enumerating the participants, that is, by establishing, creating, or populating a database of the participants, and participant access to meeting assets, such as meeting objects, meeting tools, and meeting locations. This also includes identifying each of the individual participants to individual on-line meeting sites, for example by a suitable database entry or access authorization entry. By this expedient multiple participants at an individual on-line meeting site each have participation access to the on-line meeting. The next step is publishing one or both of a list of meeting participants (which may be done in real time as part of the meeting invocation process, as in an ad hoc meeting) and an agenda, if any, to enumerated participants.

To be noted is that the meeting can be invoked by, for example, an agenda, a meeting list, or from an ad hoc environment. By invoking a meeting from an ad hoc environment, we mean invoking the meeting, generally in real time, ad hoc from an instant messaging or Lotus SameTime instant messaging environment. An ad hoc meeting would normally be conducted without a formal agenda (that is, an agenda that uses an agenda tool), and without formal invitations, but with access to voting tools, brainstorming tools, group decision support tools, collaboration tools, and the like.

The method includes the step of collecting participant inputs from the individual participants and publishing the collected participant inputs back to the participants. The participant inputs may be collected before the meeting, during the meeting, or even after the meeting.

The various participation tools, e.g., text and presentation files for collaborative efforts, files for display, the white board application, participant input tools, etc. may be invoked from an agenda tool or by a participant (e.g., in a meeting invoked from an invitation list or from an ad hoc environment). Other tools that may be invoked by the agenda tool or by a participant include participant voting tool, which is typically adapted to accept participant votes from an on-line meeting site. Normally such tools are a “one terminal equals one vote” tool, however annotation of the participant database and suitable participant coding allows “one terminal equals many votes” where the number of participant votes from an individual on-line meeting site or terminal is the number of participants identified to the individual on-line meeting site in the participant database. Voting may be anonymous or open. The votes may be published to the participants, either on-line in real time or with post-meeting minutes.

A further aspect of the method and system of the invention is interactivity, including accepting participant comments from participants, optionally with aggregation of comments, and also with publication or broadcast of the comments. Participant inputs may be accepted and published either anonymously, or with attribution, that is, with participant comments identified to participants. Publication may be one or both of on-line publication in real time or in the meeting minutes.

As a collaborative tool, the method of the system can open an object (by “object” we mean a file, a meeting or conference database, a wiki, a document, or the like), for example, an object identified in the agenda or by a participant or the convener, to identified on-line meeting participants. On line, identified meeting participants are participants with entries indicating that they have been granted access. Access to on-line meeting participants includes access to create objects, modify objects, and receive modified objects. Broadly, “access” as used herein includes accepting and recording participant inputs to the object from various participants, and updating the object, with the updated file being published to on-line meeting participants. Publication can be in real time, for example by e-mail, or by publishing participant inputs to the file, and the updated file, or in minutes of the on-line meeting.

Before or when an on-line collaboration session starts, or even during the on-line meeting for a meeting convened informally or from an ad hoc environment, a list of participants is generated, for example by the session moderator, owner, or convener. In the case of meeting convened for a future session the tool sends invitations to the prospective participants, and records responses to the invitations. The participant tool of our invention provides a single site where the meeting moderator, owner, or convener, and other persons authorized access can see the list of invitees and the individual or aggregated responses of the invitees.

During the on-line collaboration meeting the participation tool provides a constantly updated, real time enumeration of actual attendees. As participants enter and leave the session, mute their telephone, log onto or off of an instant messenger session, or log onto or off of another on-line meeting or conference, the participation tool maintains a constant, real time, attendance list. Where a participant is participating through a sub-group, with other participants, but without an individual computer link or terminal, the participation of the individual participant can be recorded by another participant. This allows the enumeration of participants to be annotated and updated thorough the course of the on-line meeting. This also allows “one terminal equals many participants” participation and voting.

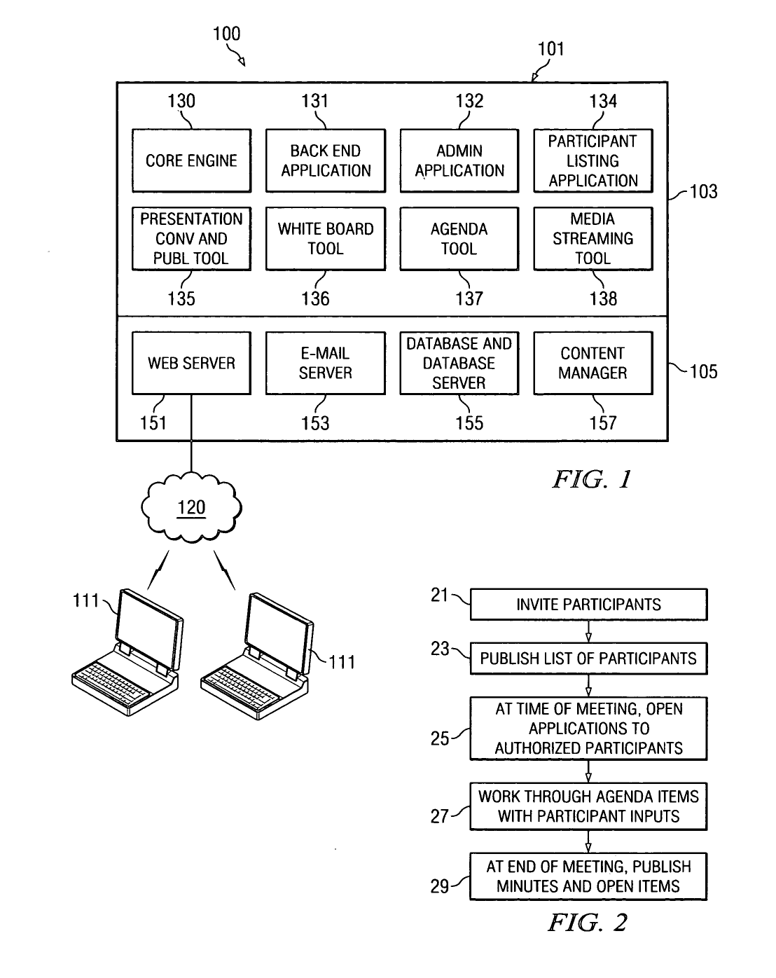

FIG. 1 illustrates an on-line meeting system, 100, including the functional and logical relationships between the on-line meeting server, 101, and individual on-line meeting participant terminals, 111. Server, 101, and individual on-line meeting participant terminals, 111, are linked together by, for example, a web server, 151, for example, via the Internet 120, an intranet, a LAN, a WAN, or other network. This is to facilitate collaboration between the participants.

The on-line meeting content may be uploaded and maintained on server, 101, or on individual terminals, 111, or on local servers identified or associated to individual participant terminals, 111. In order to control the collaboration process, all communications between server, 101, and participant terminals, 111, may be passed to or to and through server, 101. While only a single server, 101, serving multiple participant terminals, 111, is illustrated in FIG. 1 to represent a single collaboration session, server, 101, might be coupled to multiple on-line sessions since server, 101, can simultaneously process multiple collaboration sessions.

Server, 101, is constructed of a variety of different applications including, strictly by way of exemplification and not limitation, a core engine, 130, a back end application, 131, an administrative application, 132, the participant listing application, 134, described herein, a presentation conversion and publishing engine, 135, a whiteboard application, 136, an agenda tool, 137, and a media streaming application, 138. Additionally, the server, 101, includes a normal suite of server technologies, such as (by way of exemplification and illustration, and not limitation), a web server 151, an e-mail server 153 (typically providing SMTP mail functionality), a database and database application. 155 (such as such as IBM DB2 Universal Database), a media streaming application, and a content management application, 157, such as IBM Content Manager.

The core engine, 130, controls communications and interactions between all of the other applications on server, 101, as well as communication between the server, 101, and the various participant terminals, 111. This includes the interactions between the agenda tool, 137, and the participant list application, 134.

The components of the server, 101, comprise two layers, a system application layer, 103, and a standard server layer 105.

The system application layer, 103, includes system specific applications such as the whiteboard application, 136, a media streaming application, 138, a presentation conversion and publishing engine application, 135, a back-end application, 131, an administration application, 132, and the core engine, 130, the participant list application, 134, described herein, and an agenda tool, 137. To be noted is that the agenda tool, 137, is not the only means of convening or running the meeting, since the meeting can be invoked by invitation or informally, e.g., ad hoc.

The standard server layer, 105, includes such applications as the web server, 151, the mail server, 153, the database and database server, 155, and the content manager, 157.

The system, 100, also provides, through a whiteboard application, 136, a dynamic whiteboard platform. That is, the whiteboard application, 136, is accessible to those on-line participants having access through an appropriate entry in the participant list application, 134, described herein. These participants can write to the whiteboard.

As illustrated in FIG. 2, before an on-line collaboration session starts a list of participants is generated, for example by the session moderator. Note that in an ad hoc meeting, the meeting can be invoked without an invitation, and participants can be entered in the participant tool in real time, with access to tools and objects granted in real time. The tool sends invitations to the prospective participants, 21, and records responses to the invitations for access and publication, 23. The participant tool of our invention provides a single site where the meeting owner and other persons authorized access can see the list of invitees and the responses of the invitees.

During the on-line collaboration meeting the participation tool provides a constantly updated, real time enumeration of actual attendees. As participants enter and leave the session, the participation tool maintains a constant, real time, attendance list. Where a participant is participating through a sub-group, with other participants, but without an individual computer link or terminal, the participation of the individual participant can be recorded by another participant. This allows the enumeration of participants to be annotated and updated thorough the course of the on-line meeting.

The participation tool generates a time stamp as each participant enters and leaves the session.

A further aspect of the participant tool of our invention is that the tool provides enhanced information about each participant. This information includes participant attributes, such as, solely by way of exemplification and not limitation, the access authorized to the participant, the location of each participant, the tools available to each participant, a drill down for each participant, as well as scalability and extensibility, both for more participants and for more attributes per participant

As to the location of each participant, the tool provides an enumeration of each participant and the location of that participant. This allows sorting by location, so that the facilitator knows who the participants are, where they are, which participants are sharing a location and a terminal or telephone. This can be filtered and sorted by site and by participant.

The method and system of our invention establishes and publishes a list of participants in an on-line meeting, with indications of participant responses to meeting notices (such as invitations to the meeting, rescheduling the meeting, etc.). Note that establishing and publishing a list of participants can be done in real time during the meeting. The participant list tool further provides and displays, during the on-line meeting, the real-time status of the participants. Finally, the participant list tool manages the collection, display, and dissemination of inputs from participants to other participants and to the moderator.

The participant list tool provides various dynamic functions for on-line meetings. One key element is the capability for real-time, on-line rescheduling. Further functions can include importing participant lists from previous meetings and exporting participant lists to subsequent meetings, establishing and scheduling subsidiary meetings of sub-sets of participants in the original meeting, integrating meetings with agendas and agenda items and other workflow related items, and combining meetings through the participant list tool with other project workflow, agenda, and project activities. For example, a follow-on meeting may be scheduled by the participant list application based on response of individual participants to particular queries.

The interaction of the participant list described herein with an optional agenda tool enhances the individual participant's and the group's perception of the value of the on-line conference. Working with the agenda tool, 137 of FIG. 1, the participant listing application, 134 of FIG. 1, opens the various applications and files to authorized participants, block 25 of FIG. 2, and works through the agenda items with participant inputs, block 27 of FIG. 2. At the end of the session the participant listing application, 137 of FIG. 1, provides an enumeration of participants, which may have annotations of who should receive meeting minutes, open item notifications, and subsequent correspondence, block 29 of FIG. 2. This is true whether the purpose of the on-line conference is teaching a class, conducting a business meeting, or collaborating on a work item. The participant list tool described herein also can be used as a “team building” tool to develop a sense of “community” or “camaraderie” or “singleness of purpose” across separate and disparate sites. This “team building” interaction increases the effectiveness of the individual on-line meeting, the series of on-line meetings associated with a project or process, and the attainment of the project goal.

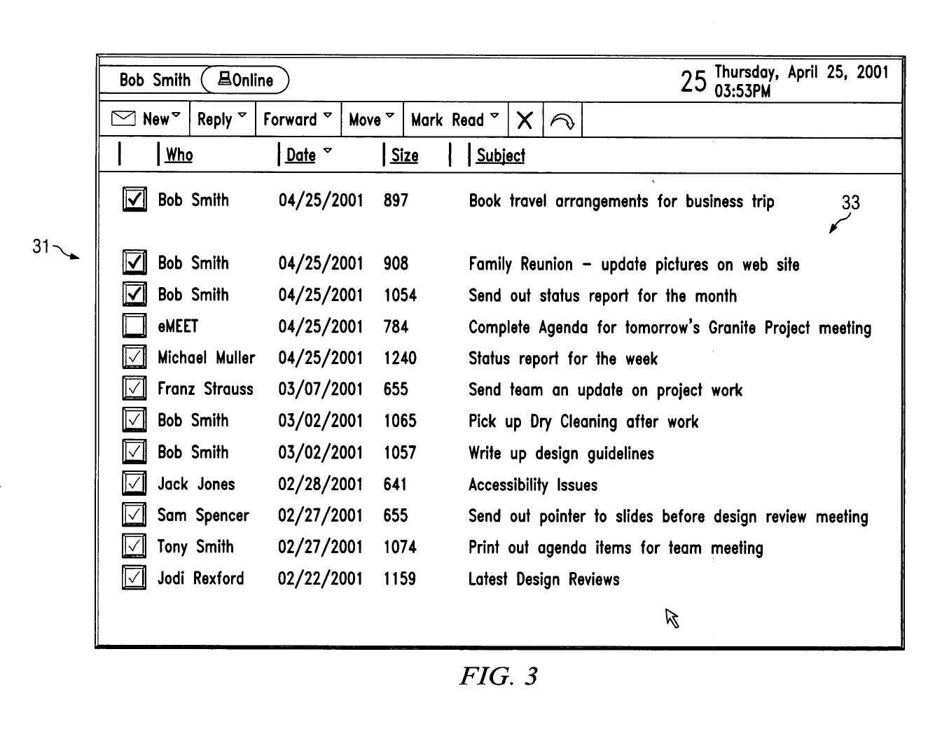

FIGS. 3-13 illustrate the screens presented to the participants. For example, FIG. 3 shows an e-mail screen, 31, with a meeting invitation, 33, inviting a participant to attend an on-line meeting.

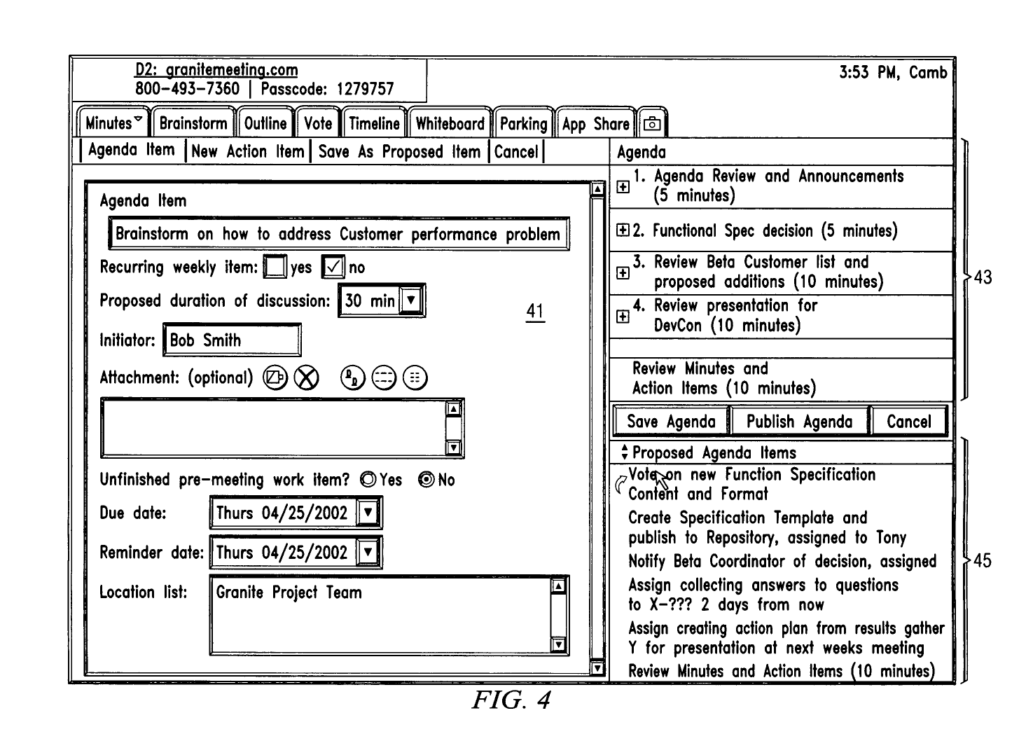

FIG. 4 shows a participant's screen, with an agenda item, 41, the meeting agenda, 43, and an enumeration of proposed agenda items, 45.

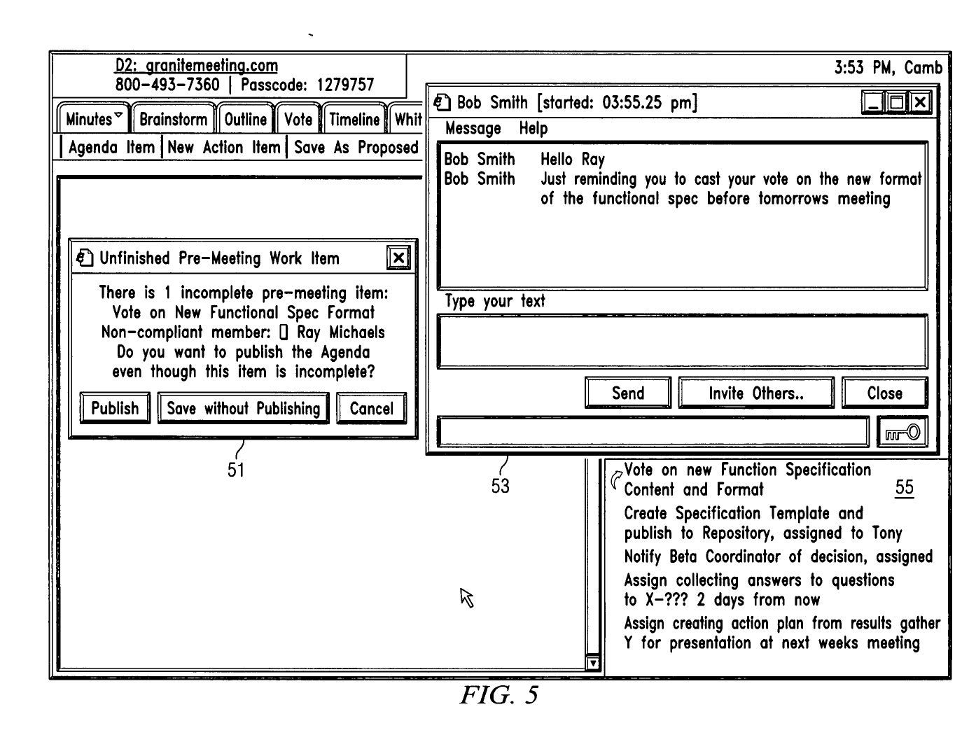

FIG. 5 shows a participant's screen with a reminder of unfinished tasks, 51, an instant message, 53, and a segment of the proposed agenda item list, 45.

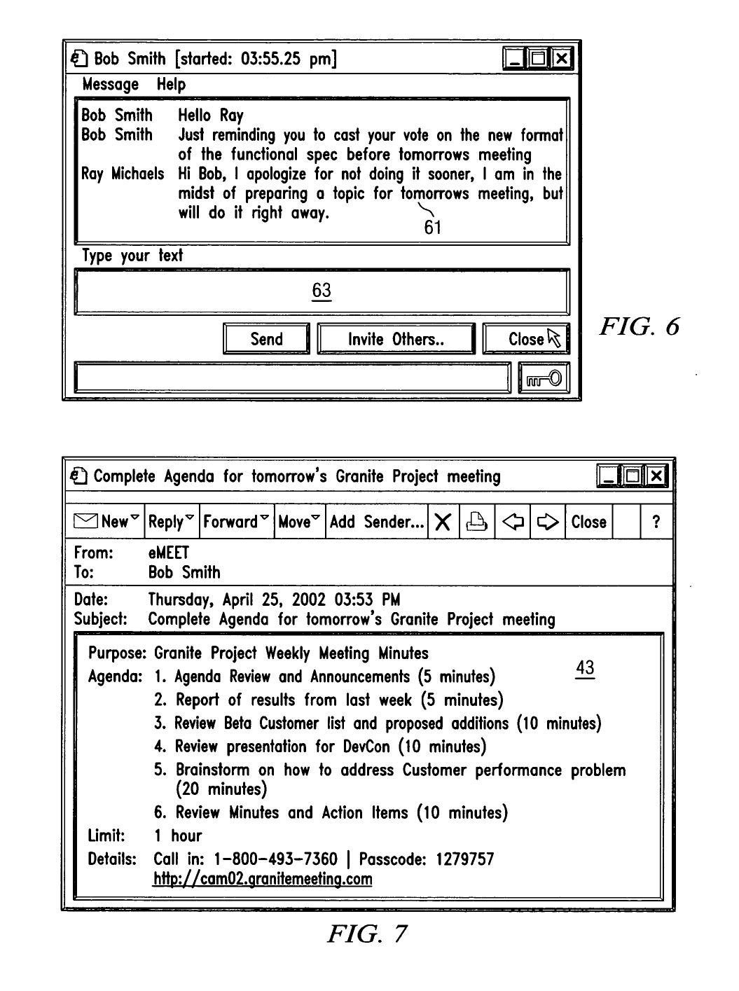

FIG. 6 illustrates the instant message panel, 61, which can also be used for “brainstorming” sessions, student questions, and “group decision support” sessions. The screen includes a panel for participant inputs.

FIG. 7 illustrates a screen display of a meeting agenda, 43.

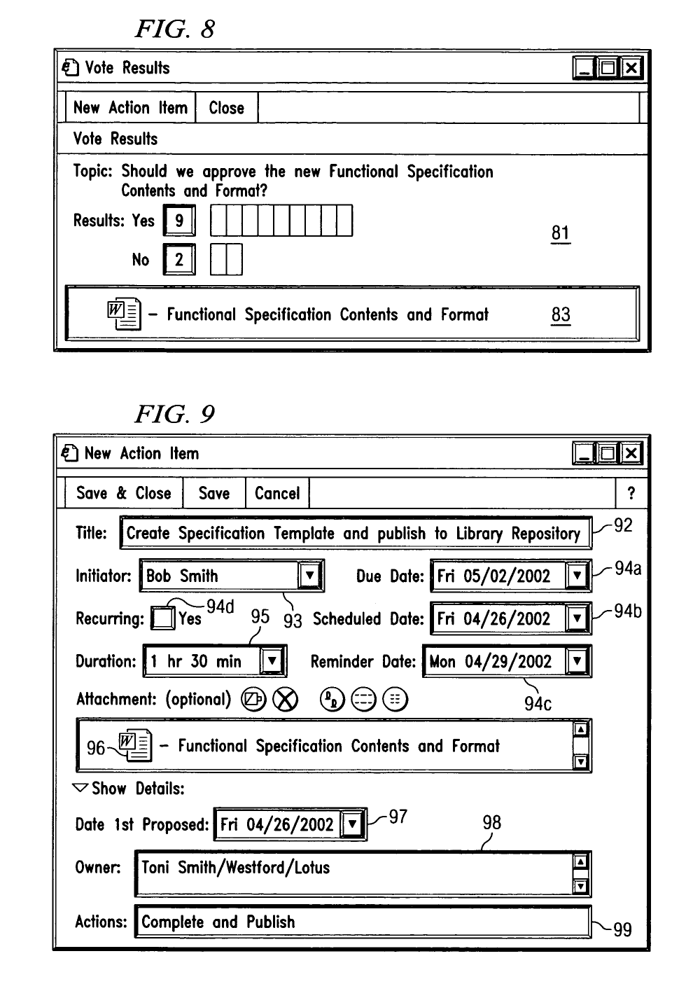

FIG. 8 illustrates a screen display of on-line voting results, 81, which may include “one terminal equals many participants” aggregated results and tallies. Also shown on the screen is a link, 83, to a document being voted on.

FIG. 9 illustrates a screen display for a new action item, 91. The display includes the action item title, 92, the name or identifier of the initiator, 93, tickler data, such as the due date, 94a, the scheduled date, 94b, the reminder date, 94c, whether recurring, 94d, and the duration, 95. Also shown is an optional link to an attachment, 96, and historical details, such as the date first proposed, the owner, 98, and the actions, 99.

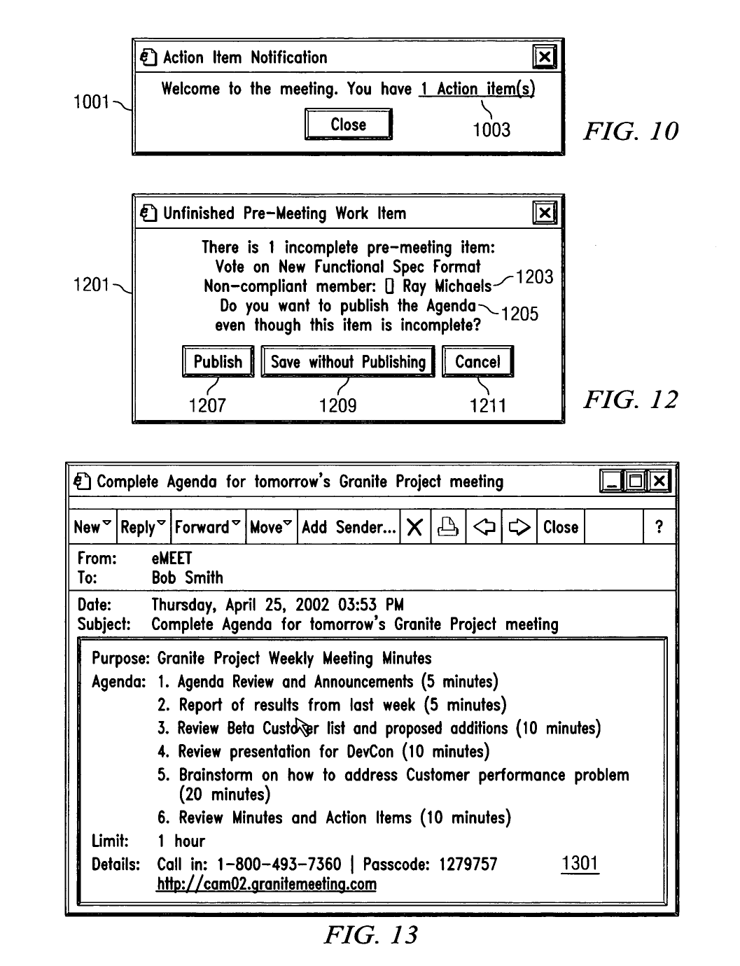

FIG. 10 illustrates a “Welcome To The Meeting” screen display, 1001, notifying a participant of a new action item, 1003.

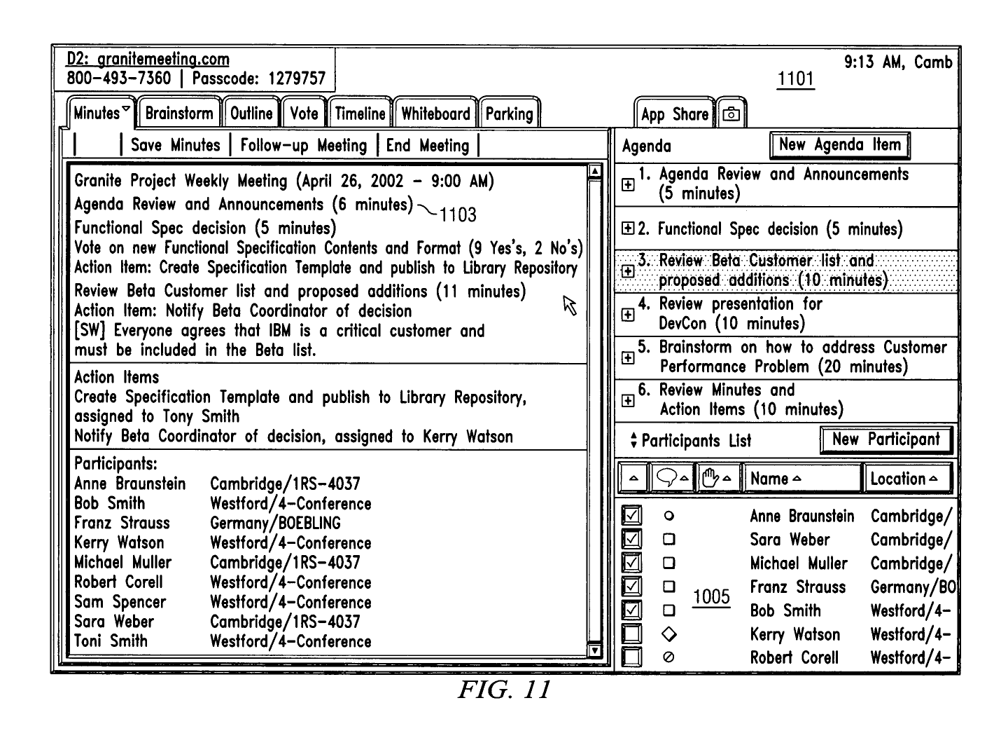

FIG. 11 illustrates a screen display of an on-line meeting agenda, 1101, a frame of the meeting agenda, 1103, and the present on-line participants, 1105.

FIG. 12 illustrates an unfinished pre-meeting work item notification, 1201, with a reminder as to the owner in non-compliance, 1203, a query as to publishing the agenda, and push buttons for publishing, 1207, saving, 1209, or canceling, 1211, the item.

FIG. 13 is a complete agenda, 1301, for a future meeting.

With respect to the tools available to each participant, the participant tool provides the moderator with such information as word processing, presentation tools, spreadsheet, desktop publishing, and e-mail tools, as well as connection speeds.

A further aspect of the participant tool is the capability of drill down for each participant. This typically provides “company directory” type data. Drilling down may optionally provide other or additional data, such as a list of documents authored by the participant, or a list of documents recently read by the participant, or major projects or accounts managed by the participant, or other organizational information that is typically of concern in the discipline of knowledge management.

Another aspect of the participant tool is its scalability and extensibility. This includes columns, cells, icons, and emoticons through which participants can provide inputs, responses, requests to speak, collaboration inputs to files, and the like, as well as extensible to additional participants or additional attributes per participant.

Integration of the above inputs enables generation of meeting minutes, including actual participants and planned participants, and the input of each participant, which may be time stamped.

A still further aspect of our invention is its capability to parameterize other collaboration tools. Such parameterization includes time stamping of various events and activities, annotations of the minutes documents, owners of each “to do” or action item, as well as the capability of tailoring user interfaces.

As to tailoring user interfaces, the participant tool provides customization of voting tools, as between, for example, radio buttons and empty fields to fill in, as well as identification indicia for each participant. Similarly, the participant tool provides customization of brainstorming tools, as between, for example, “one-computer/one-user/one-idea” modes and “one-computer/many-users/many-ideas but one-idea-per-user” modes. Similarly, in an educational setting, the participant tool provides customization of question-asking tools, as between, for example, “one-computer/one-user/one-question” modes and “one-computer/many-users/many-questions but one-question-per-user” modes.

While the invention has been described with respect to certain preferred embodiments and exemplifications, it is not intended to limit the scope of the invention thereby, but solely by the claims appended hereto.

1. A method of conducting an on-line meeting comprising:
a. establishing a database of participants and participant access rights to meeting assets;
b. identifying participants to individual on-line meeting sites whereby multiple participants at an individual on-line meeting site each have participation access to the on-line meeting;
c. invoking the meeting;
d. collecting participant inputs from participants; and
e. publishing collected participant inputs back to the participants.

2. The method of claim 1 comprising invoking the meeting from an agenda.

3. The method of claim 1 comprising invoking the meeting from a meeting invitation.

4. The method of claim 1 comprising invoking the meeting ad hoc.

5. The method of claim 1 comprising invoking participation tools.

6. The method of claim 5 comprising invoking participant input tools.

7. The method of claim 6 comprising invoking a participant voting tool adapted to accept participant votes from an on-line meeting site, where the number of participant votes from an individual on-line meeting site is the number of participants identified to the said individual on-line meeting site.

8. The method of claim 7 comprising recording votes anonymously.

9. The method of claim 7 comprising recording votes identified to participants.

10. The method of claim 7 comprising publishing votes to participants.

11. The method of claim 7 comprising publishing votes in minutes of the on-line meeting.

12. The method of claim 11 comprising publishing the minutes to on-line meeting participants.

13. The method of claim 6 comprising accepting participant comments from participants.

14. The method of claim 13 wherein the participant comments are questions.

15. The method of claim 13 wherein the participant comments are brainstorming contributions.

16. The method of claim 13 comprising recording participant comments anonymously.

17. The method of claim 13 comprising recording participant comments identified to participants.

18. The method of claim 17 comprising publishing participant comments to on-line meeting participants.

19. The method of claim 13 comprising publishing participant comments in minutes of the on-line meeting.

20. The method of claim 19 comprising publishing the minutes to on-line meeting participants.

21. The method of claim 1 comprising opening an object identified to the on-line meeting participants, and granting access to the on-line meeting participants to modify the object.

22. The method of claim 21 comprising accepting and recording participant inputs to the object from participants.

23. The method of claim 22 comprising publishing participant inputs to the object to on-line meeting participants.

24. The method of claim 23 comprising publishing participant inputs to the object in minutes of the on-line meeting.

25. The method of claim 24 comprising publishing the minutes to on-line meeting participants.

26. A computer system adapted for conducting an on-line meeting, and comprising a server including:
a. an on-line meeting participant database, said database having fields for identifying participants to individual on-line meeting sites whereby multiple participants at an individual on-line meeting site each have participation access to the on-line meeting; and
b. a collaboration application for collecting participant inputs from participants enumerated in the on-line meeting participant database and publishing collected participant inputs back to the participants.

27. The computer system of claim 26 further comprising an agenda tool for invoking on-line meeting participation tools from the agenda.

28. The computer system of claim 26 further comprising a participant voting tool adapted to accept participant votes from an on-line meeting site, where the number of participant votes from an individual on-line meeting site is the number of participants identified to the said individual on-line meeting site.

29. The computer system of claim 26 further comprising a participant comment tool for accepting comments from participants.

30. The computer system of claim 29 wherein the participant inputs are questions.

31. The computer system of claim 29 wherein the participant inputs are brainstorming contributions.

32. The computer system of claim 26 further comprising a collaboration tool for opening an object to identified on-line meeting participants, granting access to the on-line meeting participants to modify the object, and receiving and recording participant inputs to the object from participants.

33. A program product comprising computer readable program code to configure and control a computer system having an on-line participant database and on-line meeting applications, to conduct an on-line meeting, including the steps of:
a. entering on-line meeting participants in the on-line meeting participant database, said database having fields for identifying participants to individual on-line meeting sites whereby multiple participants at an individual on-line meeting site each have participation access to the on-line meeting; and
b. collecting participant inputs from participants enumerated in the on-line meeting participant database and publishing collected participant inputs back to the participants.

34. The program product of claim 33 further comprising an agenda tool for invoking on-line meeting participation tools from the agenda.

35. The program product of claim 33 further comprising a participant voting tool adapted to accept participant votes from an on-line meeting site, where the number of participant votes from an individual on-line meeting site is the number of participants identified to the said individual on-line meeting site.

36. The program product of claim 33 further comprising a participant comment tool for accepting comments from participants.

37. The program product of claim 36 wherein the participant comments are questions.

38. The program product of claim 36 wherein the participant comments are brainstorming contributions.

39. The program product of claim 33 further comprising a collaboration tool for opening an object identified to on-line meeting participants, granting access to the on-line meeting participants to modify the object, and receiving and recording participant inputs to the object from participants.
